(19) United States
(12) Patent Application Publication
(10) Pub. No.: US 2026/0008916 A1
(43) Pub. Date: Jan. 8, 2026

(54) ENHANCED THERMOPLASTIC POLYMER COMPOSITES INCORPORATING BIO-BASED NUTSHELL FILLERS AND MALEIC ANHYDRIDE FUNCTIONALIZATION

(71) Applicant: Nutjobs, Inc., Carmel, CA (US)

(72) Inventors: Jeffrey Michael Anderson, Belmont, MA (US); Richard Pieters, Scotts Valley, CA (US)

(73) Assignee: Nutjobs, Inc., Carmel, CA (US)

(21) Appl. No.: 19/257,000

(22) Filed: Jul. 1, 2025

Related U.S. Application Data
(60) Provisional application No. 63/667,357, filed on Jul. 3, 2024.

(51) Int. Cl. C08L 51/06; B29C 35/02; B29K 96/02; B29K 511/00; C08J 3/20; C08J 3/22; C08J 3/24; C08K 11/00

(52) U.S. Cl. CPC C08L 51/06; B29C 35/02; C08J 3/203; C08J 3/226; C08J 3/247; C08K 11/005; B29K 2096/02; B29K 2511/00; B29K 2995/0077; B29K 2995/0082; B29K 2995/0089; C08J 2351/06; C08K 2201/005

(57) ABSTRACT

An improved thermoplastic compound and its method of manufacture therefor are disclosed. The thermoplastic compound comprises a semicrystalline polyolefin matrix, selected from polypropylene, high-density polyethylene, or blends thereof, reinforced with a renewable, lignocellulosic nutshell particulate and compatibilized via maleic anhydride grafting. In-situ or pre-grafted maleic-anhydride functionality effects covalent interfacial bonding between the polymer and bio-filler during reactive extrusion, yielding composites with significantly enhanced tensile strength, flexural modulus, and notched-impact resistance compared to unfilled or uncoupled resins. The use of agricultural-waste nutshells as a reinforcing filler reduces material density and carbon footprint while lowering cost relative to conventional mineral fillers. The composites readily molded or extruded into structural and semi-structural parts, making them a sustainable, high-performance alternative for applications in automotive, construction, packaging, and consumer goods.

### CROSS-REFERENCE TO RELATED APPLICATIONS

This application claims priority to U.S. Provisional Application No. 63/667,357 filed on Jul. 3, 2024, and entitled “Enhanced Polypropylene Compound Utilizing Bio Nutshells and Maleic Acid Grafting”, which is incorporated herein by reference in its entirety.

### TECHNICAL FIELD

The present disclosure generally relates to thermoplastic compositions and methods of manufacturing and uses thereof, and more particularly, to polypropylene and high-density polyethylene polymer compositions reinforced with bio-based nutshell fillers, wherein the polymer compositions are chemically modified through maleic anhydride grafting to significantly enhance mechanical properties, thermal stability, and interfacial adhesion.

### BACKGROUND

Polypropylene (PP) and high-density polyethylene (HDPE) are widely utilized thermoplastic polymers due to their desirable attributes, including but not limited to, low material density, high chemical resistance, and ease of processing. Despite these advantages, unmodified PP and HDPE often exhibit insufficient strength, impact resistance, and thermal stability required for demanding or high-performance applications. This inherent limitation restricts the broader adoption of such materials in sectors such as automotive, construction, packaging, and consumer products, where superior mechanical and thermal properties are highly valued.

To address these shortcomings, researchers and industry professionals have explored the incorporation of various fillers and reinforcements into polymer matrices. Typical reinforcing fillers include synthetic fibers, such as glass or carbon fibers, and/or mineral fillers such as talc or calcium carbonate. While these traditional fillers improve mechanical properties, they are often derived from non-renewable sources, are energy-intensive to produce, and may negatively impact the recyclability or sustainability profile of the resulting composite material.

As sustainability considerations become increasingly relevant in materials selection, there is a growing interest in leveraging bio-based fillers derived from renewable agricultural waste products. Nutshells, such as almond shells, represent an abundant and renewable lignocellulosic biomass and utilizing nutshell-derived fillers presents an attractive sustainable alternative due to the low environmental impact, availability, cost-effectiveness, and intrinsic mechanical stiffness thereof.

### BRIEF SUMMARY OF THE INVENTION

The present disclosure is directed to a thermoplastic composition and a method of manufacturing the same. The thermoplastic composition comprises a thermoplastic base polymer selected from polypropylene, high-density polyethylene, or blends thereof; a reinforcing filler, wherein the reinforcing filler is a bio-based lignocellulosic particulate; a reactive coupling agent comprising a maleic-anhydride-grafted polyolefin; and optionally one or more stabilizers, lubricants, colorants, or other processing aids.

The present disclosure further provides for a method of manufacturing the thermoplastic composite material. The method may comprise the following steps: mixing a thermoplastic polymer, a bio-based lignocellulosic particulate filler, and a reactive coupling agent comprising a maleic-anhydride-grafted polyolefin, and a heat stabilizer to form a substantially homogeneous mixture; and extruding the mixture under reactive-compounding conditions sufficient to plasticize the thermoplastic base polymer, chemically grafting additional maleic-anhydride functionalities onto the polyolefin backbone, and uniformly dispersing the bio-based lignocellulosic particulate filler, thereby forming a moldable extrudate. The resulting moldable material may thereafter be formed into a final article using a melt-processing technique selected from one of a compression molding, an injection molding, and a profile extrusion process.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The embodiments set forth in the drawings are illustrative and exemplary in nature and not intended to limit the subject matter. The following detailed description of the illustrative embodiments can be understood when read in conjunction with the following drawings, where like structure is indicated with like reference numerals and in which:

FIG. 1 is an exemplary process flow diagram detailing the steps of the present method for forming a moldable thermoplastic composite material.

### DETAILED DESCRIPTION OF THE INVENTION

While the present disclosure may be described with respect to specific applications or industries, those skilled in the art will recognize the broader applicability of the disclosure.

Those having ordinary skill in the art will recognize the terms such as “a”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

Features shown in one FIGURE may be combined with, substituted for, or modified by, features shown in any of the FIGURES. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

For consistency and convenience, directional adjectives are employed throughout this detailed description corresponding to the illustrated embodiments. Those having ordinary skill in the art will recognize that terms such as “above”, “below”, “upward”, “downward”, “top”, “bottom”, etc., may be used descriptively relative to the FIGURES, without representing limitations on the scope of the invention, as defined by the claims. Any numerical designations, such as “first” or “second” are illustrative only and are not intended to limit the scope of the disclosure in any way.

Provided herein are thermoplastic compositions and methods for their manufacture and uses thereof. In one aspect, the present disclosure provides a thermoplastic composition comprising (1) a thermoplastic base polymer selected from polypropylene, high-density polyethylene, or blends thereof; (2) a renewable, lignocellulosic particulate filler derived from nut-processing waste; (3) a reactive coupling agent; and, optionally, (4) one or more stabilizers, lubricants, colorants, or other processing aids. The composition can be compounded on conventional twin-screw extruders, long-fiber-thermoplastic (LFT-D) lines, or other reactive-extrusion equipment known to those skilled in the art. The resulting extrudate may constitute a moldable material that can be injection-molded, compression-molded, or profile-extruded into a broad range of functional products.

In a general sense, the present invention addresses a need that persists for a composite thermoplastic material that effectively integrates bio-based nutshell fillers into PP or HDPE matrices while significantly enhancing mechanical, thermal, and rheological properties. Such integration necessitates innovative compatibilization strategies to overcome interfacial incompatibilities and achieve superior composite performance. Maleic anhydride grafting, where maleic anhydride is chemically grafted onto the polymer backbone or introduced via functional additives, has demonstrated promise in addressing these interfacial challenges by forming robust chemical bonds between the polymer matrix and bio-based fillers. Said another way, the present invention addresses the need for a sustainable, high-performance polymer composite by combining PP or HDPE with bio-based nutshell fillers and employing maleic anhydride-based compatibilization strategies. This combination uniquely achieves enhanced mechanical, thermal, and interfacial performance properties required for demanding industrial applications while also advancing sustainability goals.

Accordingly, the moldable materials of the present invention are well suited for a variety of end-use applications, including, but not limited to, rigid or semi-rigid packaging, consumer-electronics housings, appliance components, furniture, and horticultural or agricultural containers, i.e., any molded or extruded article that benefits from a combination of light weight, enhanced stiffness-to-weight ratio, improved impact toughness, thermal stability, and increased renewable content.

### Composition

### 1. Thermoplastic Base Polymer

The thermoplastic base polymer may be any suitable olefinic resin that furnishes the composite with melt-processability, chemical resistance, and a semicrystalline framework for stress transfer. Suitable olefinic resins include, without limitation, polypropylene (PP) homopolymers, random or impact copolymers; high-density polyethylene (HDPE) homopolymers or copolymers; and blends thereof. In general, the thermoplastic base polymer serves as the continuous matrix phase of the composite. The polymer (or polymer blend) desirably exhibits a semicrystalline morphology, a melting temperature in excess of about 125° C., and a melt-flow rate (MFR) that supports thorough wet-out of the lignocellulosic filler without excessive fiber breakage.

For polypropylene materials, homopolymers or random copolymers containing no more than about seven weight-percent comonomer and displaying an MFR of about 1 to 50 g/10 min (230° C./2.16 kg) are suitable, with medium-flow grades (MFR≈10-20 g/10 min) often preferred for long-fiber or direct-compounding processes. An example of a suitable polypropylene is sold under the tradename Braskem® CP1200B Polypropylene Homopolymer, commercially available from Braskem America Inc., of Philadelphia, Pennsylvania, USA. However, it is understood that any polypropylene exhibiting comparable melt-flow characteristics, density, and thermal stability may be substituted without departing from the scope of the invention.

High-density polyethylene grades useful in the present invention typically possess a density of at least 0.945 g cm⁻³ and an MFR of about 0.1 to 25 g/10 min (190° C./2.16 kg). An example of a suitable high-density polyethylene is sold under the tradename Marlex® 9035 and related grade Marlex® 9045 high-density polyethylene, commercially available from Chevron Phillips Chemical Company LP, the Woodlands, Texas, USA. However, it is understood that any high-density polyethylene exhibiting comparable melt-flow characteristics, density, and thermal stability may be substituted without departing from the scope of the invention.

In some embodiments, where a balance of stiffness and low-temperature impact is required, blends of PP and HDPE may be employed.

In general, the weight percentage (wt %) of the thermoplastic base polymer within the total composition of the present invention may range from about 40 wt % to about 90 wt % of the total composition. In various embodiments, the wt % of the thermoplastic base polymer may range from about 50 wt % to about 80 wt %, or from about 60 wt % to about 75 wt % within the total composition of the present invention.

### 2. Bio-Based Reinforcing Filler

The bio-based reinforcing filler may be any lignocellulosic particulate derived from nut-processing waste, including nut shells, nut hulls, or a combination of nut shells and nut hulls. Generally, these nut shells and nut hulls may be derived from a variety of nuts or nut types. Non-limiting examples include acorn, American beech, almond, breadfruit, candlenut, chestnuts, peanuts, hazelnuts, kola nuts, palm nuts, red bopple nuts, cashews, coconuts, hickory, pecans, Jack nuts, pistachio, walnuts, pine nuts, ginkgo nuts, Brazil nuts, macadamia, and paradise nuts. In one embodiment, the bio-based reinforcing filler is almond powder derived from almond shells and/or hulls.

The bio-based reinforcing filler component may be dried to a residual moisture content of less than about 0.5 wt % water, and more preferably to less than about 0.1 wt % water prior to compounding. Drying is typically carried out at a temperature of about 80° C. to about 120° C. for a predetermined time period that is sufficient to reach the desired moisture level and may be performed under an inert atmosphere (e.g., nitrogen) or under reduced pressure to accelerate water removal and prevent oxidative darkening of the filler.

The bio-based reinforcing filler may be milled and screened to a controlled size range before introduced into the composite. For example, the size of the bio-based filler component may be less than or equal to 500 μm. Particles within this limit disperse uniformly in the molten polyolefin, flow through injection-mold or compression-press gates without clogging, and present sufficient surface area for chemical coupling to the maleic-anhydride graft.

Optionally, the bio-based reinforcing filler may be surface-treated prior to compounding to promote chemical bonding to the maleic-anhydride-grafted polypropylene or HDPE matrix. The treatment may include one or more of the following non-limiting operations: (i) a mild alkaline or oxidative wash that removes surface waxes and exposes additional hydroxyl groups; (ii) a light application of a coupling primer such as an amino-, epoxy-, or anhydride-functional silane, or a low-molecular-weight maleic-anhydride oligomer, that deposits reactive moieties on the filler surface; and/or (iii) a thermal conditioning step that drives off volatiles and raises surface energy. These optional treatments may aid to increase the availability of hydroxyl or other nucleophilic sites on the lignocellulosic substrate, thereby facilitating in-situ esterification or acid-base interactions with the maleic-anhydride functionality present on the compatibilized polyolefin. As a result, the treated filler may disperse more uniformly in the melt and adhere more strongly to the matrix, yielding composites that exhibit higher tensile and flexural strength as well as improved notched-impact resistance.

In general, the weight percentage (wt %) of the bio-based reinforcing filler component may range from about 5 wt % to about 80 wt % of the total composition of the present invention. In various embodiments, the wt % of the bio-based filler may range from about 8 wt % to about 70 wt %, or from about 10 wt % to about 60 wt % of the total composition of the present invention.

### 3. Reactive Coupling Agent

The composition may further include a reactive coupling agent or adhesion promoter that functions to chemically bond the bio-based filler to the thermoplastic matrix, thereby improving dispersion and interfacial adhesion. Preferably, the coupling agent is a maleic-anhydride-grafted polyolefin (MA-g-PO), i.e., a polypropylene- or high-density-polyethylene-backbone resin bearing cyclic maleic-anhydride groups. During melt compounding, the maleic-anhydride rings open and form ester or acid-base linkages with hydroxyl and phenolic groups on the lignocellulosic filler surface, while the polyolefin backbone of the coupling agent co-crystallizes and entangles with the surrounding polypropylene or HDPE matrix. The resulting covalently bonded interphase suppresses filler pull-out, promotes uniform dispersion, and enables efficient stress transfer, thereby yielding composites with increased tensile strength, flexural modulus, and notched-impact resistance relative to uncoupled blends.

Alternatively, the maleic-anhydride functionality may be grafted directly onto the polypropylene or HDPE matrix resin itself, either in a separate grafting step or in-situ during melt compounding, so that the grafted matrix performs the coupling role without the need for a discrete MA-g-PO additive. Such grafted-matrix embodiments fall within the scope of the present invention, provided the graft level and melt-flow characteristics satisfy the ranges set forth below.

Suitable MA-g-PO grades contain from about 0.3 wt % to about 1.5 wt % grafted maleic anhydride and exhibit a melt-flow rate of about 5 g/10 min to about 30 g/10 min (ASTM D1238). An example of a suitable reactive coupling agent is sold under the tradename BYK Priex 20097-A maleated polypropylene, commercially available from BYK (Germany). However, it is understood that any MA-g-PO exhibiting comparable graft level, melt-flow behavior, and thermal stability may be employed without departing from the scope of the invention.

In general, the coupling agent is present from about 0.5 wt % to about 5.0 wt % of the total composition of the present invention. In various embodiments, the coupling agent is present from about 0.75 wt % to about 3.0 wt %, or from about 1.0 wt % to about 2.0 wt % of the total composition of the present invention.

### 4. Stabilizers and Processing Aids

The composition may further include one or more additives selected from stabilizers, lubricants, pigments, and/or melt processing aids that protect the polyolefin matrix from thermo-oxidative degradation during compounding and molding, preserve color and mechanical properties in service, and/or optionally reduce melt viscosity or die pressure for smoother processing.

One example of a suitable stabilizer is sold under the tradename BYK MAX HS 4334, commercially available from BYK (Germany). This master-batch provides a balanced hindered-phenol/phosphite antioxidant system pre-dispersed in a polyolefin carrier together with a low-level internal lubricant.

In general, the weight percentage (wt %) of the stabilizer may range from about 0.1 wt % to about 5.0 wt % of the total composition of the present invention. In various embodiments, the wt % of the stabilizer may range from about 0.5 wt % to about 4.0 wt %, or from about 1.0 wt % to about 3.0 wt % of the total composition of the present invention.

### Method

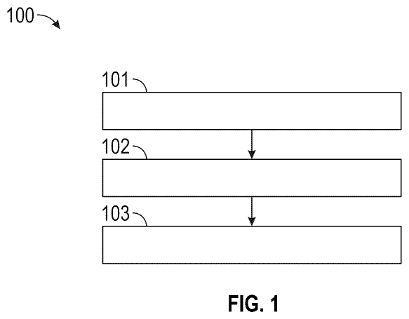

The thermoplastic composition of the present disclosure may be formed or otherwise manufactured via the present method. More particularly, referring now to the drawings, FIG. 1 shows a process flow diagram detailing the steps of the present method 100 for forming a moldable thermoplastic composite material.

Referring to FIG. 1, at step 101, the thermoplastic base polymer, bio-based filler, reactive coupling agent, and any optional stabilizers, lubricants, colorants or processing aids are weighed to predetermined weight-percent ratios. The components may be premixed to yield a uniform feedstock. Mixing may be accomplished by any suitable means known in the art, such as tumble blending or hand mixing.

At step 102, the premix may be extruded under reactive compounding conditions to plasticize the polymer, uniformly disperse the filler, and effect in-situ grafting of maleic-anhydride groups onto the polyolefin backbone. It is contemplated that any suitable melt-extrusion apparatus known to those skilled in the relevant art may be employed, including, but not limited to, co-rotating or counter-rotating twin-screw extruders, single-screw extruders, continuous kneaders, or planetary mixers. In one non-limiting embodiment, the premix is fed to a twin-screw extruder such as a Leistritz® ZSE-60HP co-rotating twin-screw extruder equipped with a ZSG-75P side feeder.

At step 103, the resulting extrudate, herein referred to as the moldable material, may be formed into final articles or end products using conventional melt-processing techniques such as one of a compression molding process, an injection molding process, a profile extrusion process, or a like process.

### EXAMPLES

The following non-limiting examples and data illustrate various aspects and benefits of the thermoplastic compositions and methods disclosed herein. While the foregoing examples employ polypropylene or HDPE matrices, almond-shell filler, and maleic-anhydride-grafted polyolefin coupling agents, it will be understood by those skilled in the art that similar synergistic improvements may be achieved using other semicrystalline thermoplastics, alternative lignocellulosic bio-fillers, or different reactive coupling chemistries, as are commensurate with the scope of the present disclosure.

The compositions disclosed herein are made according to the general methods described above.

### 1. Polypropylene/Nutshell Composites

a. Preparation

In the testing example, ground almond-shell powder derived from agricultural waste was used as the bio-based filler. The ground almond-shell powder was milled and sieved to a median particle size of ≤500 μm and placed in a convection oven at about 100° C. for ≥24 hours. Braskem® CP1200B polypropylene homopolymer served as the base resin. A commercial heat-stabilizer masterbatch (BYK MAX HS 4334, containing hindered phenol and phosphite antioxidants in a polyolefin carrier) was incorporated to protect the matrix during processing. Inventive formulations additionally contained a maleic-anhydride-grafted polyolefin coupling agent (BYK Priex 20097-A, maleated polypropylene), to promote chemical coupling and improve interfacial adhesion.

For each formulation (Table 1), the filler, base resin, stabilizer, and, where applicable, the coupling agent, were weighed to their target weight percentages and hand-mixed until homogeneous. The premix was then fed into a twin-screw compounding extruder (e.g., Leistritz® ZSE-60HP series; all zones at 200° C., screw at 67.1 rpm) to plasticize, disperse the filler, and effect in-situ grafting of the anhydride groups. The extruded melt was discharged and compression-molded into 18″×18″ ASTM test plaques using a Dieffenbacher 2500 T hydraulic press. For plaques of 3 mm thickness, a single charge was compressed at 200 bar (≈4181 kN) for 50 seconds. For 0.5″ (≈12.7 mm) plaques, three sequential charges were placed, clamp pressure was reduced to 150 bar (≈3135 kN), and the hold time extended to 300 seconds. After cooling under pressure, plaques were demolded for subsequent mechanical testing.

TABLE 1
Polypropylene/Nutshell Composite Formulations

| | Filler | Base Resin | Heat Stabilizer | Coupling Agent |
|---|---|---|---|---|
| Example | (wt %) | (wt %) | (wt %) | (wt %) |
| 1 | 50 | 48.5 | 1.5 | 0 |
| 2 | 50 | 47 | 1.5 | 1.5 |
| 3 | 30 | 67.9 | 2.1 | 0 |
| 4 | 30 | 65.8 | 2.1 | 2.1 |
| 5 | 22 | 75.66 | 2.34 | 0 |
| 6 | 22 | 73.32 | 2.34 | 2.3 |
| 7 | 5 | 92.15 | 2.85 | 0 |
| 8 | 5 | 89.3 | 2.85 | 2.85 |

b. Mechanical Properties

For each formulation detailed in Examples 1-8, five specimens were prepared for each mechanical test. After conditioning, the molded plaques were trimmed to remove flash and then waterjet cut into the required ASTM geometries (D638 tensile bars, D790 flexural beams, D256 notched-Izod specimens) before testing.

TABLE 2
Tensile Strength

| | | Coupling | Tensile | % Gain (tensile strength) |
|---|---|---|---|---|
| | Filler | Agent | Strength | vs. uncoupled at same |
| Example | (wt %) | (wt %) | (MPa) | filler loading |
| 1 | 50 | 0 | 15.02 | — |
| 2 | 50 | 1.5 | 23.86 | +59% |
| 3 | 30 | 0 | 20.41 | — |
| 4 | 30 | 2.1 | 28.33 | +39% |
| 5 | 22 | 0 | 23.09 | — |
| 6 | 22 | 2.3 | 29.13 | +26% |
| 7 | 5 | 0 | 28.42 | — |
| 8 | 5 | 2.85 | 30.54 | +7% |

Table 2 presents the mean tensile yield strengths, determined on five 0° (flow-direction) specimens and tested per ASTM D638 at a crosshead speed of 1 mm/min; all values are reported in arithmetic means.

As shown, the uncoupled formulations (Examples 1, 3, 5, 7) exhibit a marked decline in tensile yield strength as nutshell loading increases, dropping from 28.42 MPa at 5 wt % filler to 15.02 MPa at 50 wt % filler. By contrast, incorporation of the maleic-anhydride-grafted polypropylene coupling agent (Examples 2, 4, 6, 8) reverses this trend at every filler level: with 5 wt % shell and 2.85 wt % MA-g-PP, tensile strength rises to 30.54 MPa (+7%), and with 22 wt % shell and 2.3 wt % MA-g-PP it increases to 29.13 MPa (+26%). At 30 wt % filler and 2.1 wt % coupling agent the strength jumps to 28.33 MPa (+39%), and the most dramatic improvement occurs at 50 wt % filler with 1.5 wt % MA-g-PP, where tensile yield strength climbs to 23.86 MPa, a 59 percent improvement over the corresponding filled formulation without the coupling agent. These results confirm that in-situ grafting of maleic anhydride markedly improves stress transfer and interfacial adhesion between the polypropylene matrix and the bio-based filler.

TABLE 3
Flexural Modulus

| | | | | % Change vs. |
|---|---|---|---|---|
| | | | Flexural | uncoupled at |
| | Filler | Coupling Agent | Modulus | same filler |
| Example | (wt %) | (wt %) | (MPa) | loading |
| 1 | 50 | 0 | 2239.04 | — |
| 2 | 50 | 1.5 | 2434.09 | +8.7% |
| 3 | 30 | 0 | 2026.10 | — |
| 4 | 30 | 2.1 | 2021.91 | −0.2% |
| 5 | 22 | 0 | 1939.70 | — |
| 6 | 22 | 2.3 | 1986.78 | +2.4% |
| 7 | 5 | 0 | 1766.44 | — |
| 8 | 5 | 2.8 | 1780.84 | +0.8% |

Flexural modulus was measured according to ASTM D790 on five 0° (flow direction) specimens. The support span was set to 16 times the specimen thickness, and a crosshead speed was chosen to impart a strain rate of 0.01s⁻¹. Arithmetic mean values are reported in Table 3.

As summarized in Table 3, the uncoupled control composites exhibit increasing stiffness with higher nutshell loadings, rising from 1766 MPa at 5 wt % filler up to 2239 MPa at 50 wt % filler. Introduction of the maleic-anhydride-grafted polypropylene coupling agent yields modest additional gains in flexural modulus at most filler levels. At the highest loading (50 wt % shell), coupling increases modulus to 2434 MPa (+8.7%). At 22 wt % filler the modulus rises to 1987 MPa (+2.4%), and at 5 wt % filler to 1781 MPa (+0.8%). A slight decrease (−0.2%) is observed at 30 wt % filler (2021 MPa vs. 2026 MPa uncoupled control), indicating that coupling maintains or slightly enhances stiffness across the range of filler contents. These results confirm that in-situ grafting of maleic anhydride preserves, and in some cases, augments the rigidity imparted by the bio-based filler.

TABLE 4
Impact Strength (Izod)

| | | | | % Change vs. |
|---|---|---|---|---|
| | | | Impact | uncoupled at |
| | Filler | Coupling Agent | Resistance | same filler |
| Example | (wt %) | (wt %) | (J m⁻¹) | loading |
| 1 | 50 | 0 | 12.18 | — |
| 2 | 50 | 1.5 | 11.99 | −1.6% |
| 3 | 30 | 0 | 21.49 | — |
| 4 | 30 | 2.1 | 21.49 | 0% |
| 5 | 22 | 0 | 20.42 | — |
| 6 | 22 | 2.3 | 21.41 | +4.9% |
| 7 | 5 | 0 | 20.86 | — |
| 8 | 5 | 2.8 | 21.21 | +1.7% |

Impact strength was measured on notched Izod specimens prepared and tested per ASTM D256 (23° C., 2.75 J pendulum) using five 0° (flow-direction) specimens. As summarized in Table 4, the uncoupled control composites exhibit impact resistances of 12.18 J/m at 50 wt % filler, 21.49 J/m at 30 wt %, 20.42 J/m at 22 wt %, and 20.86 J/m at 5 wt %. Incorporation of the maleic-anhydride-grafted polypropylene coupling agent largely preserves or modestly enhances toughness across all filler levels. Notably, at 22 wt % nutshell loading, the coupling agent increases impact resistance by approximately 5%—from 20.42 J/m (Example 5) to 21.41 J/m (Example 6)—demonstrating a significant improvement in notched-Izod performance for the filled composite.

### 2. High-Density Polyethylene/Nutshell Composites

a. Preparation

High-density polyethylene/nutshell composites were prepared in an analogous fashion to the polypropylene materials described above, with the following substitutions and particulars. Marlex® 9035/9045 HDPE replaced the Braskem® CP1200B PP as the base polymer, and a maleic-anhydride-grafted HDPE coupling agent (e.g., MA-g-PE) took the place of the MA-g-PP. The same masterbatch (BYK MAX HS 4334) was utilized as the heat stabilizer. Table 5 summarizes the component weight percentages for the two HDPE systems.

TABLE 5
High-Density Polyethylene/Nutshell Composite Formulations

| | Filler | Base Resin | Heat Stabilizer | Coupling Agent |
|---|---|---|---|---|
| Example | (wt %) | (wt %) | (wt %) | (wt %) |
| 9 | 25 | 74 | 1 | 0 |
| 10 | 25 | 69 | 1 | 5 |

b. Mechanical Properties of High-Density Polyethylene/Nutshell Composites

TABLE 6
Tensile Yield Strength

| | Filler | Coupling Agent | Tensile Strength | % Gain vs. |
|---|---|---|---|---|
| Example | (wt %) | (wt %) | (MPa) | Example 9 |
| 9 | 25 | 0 | 11.1 | — |
| 10 | 25 | 5 | 17.6 | +59% |

Tensile yield strength was measured in accordance with ASTM D638. As shown in Table 6, the uncoupled HDPE composite (Example 9) exhibits a tensile yield strength of 11.1 MPa. Incorporation of the maleic-anhydride-grafted HDPE coupling agent (Example 10) raises the tensile yield strength to 17.6 MPa, a 59% improvement over the uncoupled blend, confirming that maleic-anhydride coupling markedly enhances stress transfer and interfacial adhesion in HDPE/nutshell composites.

TABLE 7
Flexural Modulus

| | Filler | Coupling Agent | Flexural | % Gain vs. |
|---|---|---|---|---|
| Example | (wt %) | (wt %) | Modulus (MPa) | Example 9 |
| 9 | 25 | 0 | 863 | — |
| 10 | 25 | 5 | 922 | +7% |

Flexural modulus was measured in accordance with ASTM D790. As shown in Table 7, the uncoupled HDPE composite (Example 9) exhibits a flexural modulus of 863 MPa. Incorporation of the maleic-anhydride-grafted HDPE coupling agent (Example 10) increases the flexural modulus to 922 MPa, representing a 7% gain over the uncoupled blend and demonstrating that reactive coupling preserves and modestly enhances the stiffness imparted by the bio-based filler.

TABLE 8
Melt-Flow Index

| | Filler | Coupling Agent | MFI | % Gain vs. |
|---|---|---|---|---|
| Example | (wt %) | (wt %) | (g/10 min) | Example 9 |
| 9 | 25 | 0 | 19.64 | — |
| 10 | 25 | 5 | 20.32 | +3% |

Melt-flow index (MFI) was measured in accordance with ASTM D1238 at 190° C. under a 2.16 kg load. As shown in Table 8, the uncoupled HDPE composite (Example 9) exhibits an MFI of 19.64 g/10 min. Incorporation of maleic-anhydride-grafted HDPE (Example 10) increases the MFI to 20.32 g/10 min, a 3% gain over the uncoupled blend. This slight increase in flowability demonstrates that reactive coupling imparts interfacial adhesion benefits without compromising processability.

In the manner described above, the present teachings confer several synergistic benefits such as pronounced gains in tensile strength, flexural modulus, and notched-impact resistance compared with the corresponding unfilled or uncoupled resins. Moreover, by replacing mineral additives with agricultural-waste by-products, these materials not only reduce density and carbon footprint but also offer cost advantages over glass- or talc-filled grades. The broad tunability of polymer type (PP, HDPE, or blends), filler loading, and grafting level enables design of composites for a wide spectrum of structural and semi-structural applications ranging from packaging and consumer goods to automotive, appliance, and horticultural components, thus providing a high-performance, sustainable and environmentally responsible alternative to traditional polyolefin formulations.

The detailed description and the drawings or FIGURES are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Benefits, other advantages, and solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claims.

1. A polymer composition comprising:
a thermoplastic base polymer selected from one of polypropylene, and high-density polyethylene, or blends thereof;
a reinforcing filler, wherein the reinforcing filler is a bio-based lignocellulosic particulate; and
a reactive coupling agent comprising a maleic-anhydride-grafted polyolefin.

2. The polymer composition of claim 1, wherein the base polymer is a polypropylene homopolymer.

3. The polymer composition of claim 2, wherein the base polymer is a high-density polyethylene.

4. The polymer composition of claim 1, wherein the reinforcing filler is almond shell powder having a particle size of less than 500 μm.

5. The polymer composition of claim 4, wherein the reinforcing filler is present in an amount from about 10 weight percent to about 60 weight percent of the total composition.

6. The polymer composition of claim 1, further comprising one or more additives selected from stabilizers, lubricants, colorants, and melt processing aids.

7. The polymer composition of claim 1, wherein the reactive coupling agent is present in an amount of from about 0.3 weight percent to about 1.5 weight percent of the total composition.

8. The polymer composition of claim 1, wherein the composite exhibits a flexural modulus of at least 1,800 MPa.

9. The polymer composition of claim 1, wherein the composite exhibits a notched Izod impact resistance of at least 20 J/m.

10. The polymer composition of claim 1, wherein the composite exhibits a melt flow index (MFI) of from about 5 to about 30 g/10 min.

11. A polymer composition comprising:
a thermoplastic base polymer selected from polypropylene homopolymers, high-density polyethylene homopolymers, or blends thereof, wherein the thermoplastic base polymer is present in an amount of from 40 wt % to about 90 wt % of the total composition;
a reinforcing filler comprising a bio-based lignocellulosic particulate having a median particle size of less than 500 μm and present in an amount from about 10 wt % to about 60 wt % of the total composition;
a reactive coupling agent comprising a maleic-anhydride-grafted polyolefin present in an amount from about 0.3 wt % to about 1.5 wt % of the total composition; and
a heat stabilizer present in an amount from about 0.1 wt % to about 5 wt % of the total composition.

12. The polymer composition of claim 11, wherein the reinforcing filler comprises almond-shell powder.

13. The polymer composition of claim 11, wherein the reactive coupling agent is a maleic-anhydride-grafted polypropylene.

14. The polymer composition of claim 11, wherein the composition exhibits a flexural modulus of at least 1,800 MPa.

15. The polymer composite of claim 11, wherein the composition exhibits a tensile yield strength of at least 25 MPa.

16. The polymer composite of claim 11, wherein the composition exhibits a notched-Izod impact resistance of at least 20 J/m.

17. A method of manufacturing a moldable thermoplastic composite material comprising the steps of:
mixing a thermoplastic polymer, a bio-based lignocellulosic particulate filler, and a reactive coupling agent comprising a maleic-anhydride-grafted polyolefin, and a heat stabilizer to form a substantially homogeneous mixture; and
forming a moldable extrudate by extruding the substantially homogeneous mixture under reactive-compounding conditions sufficient to plasticize the thermoplastic base polymer, chemically graft additional maleic-anhydride functionalities onto a polyolefin backbone, and uniformly disperse the bio-based lignocellulosic particulate filler.

18. The method of claim 17, wherein:
the thermoplastic polymer is selected from the group consisting of polypropylene, high-density polyethylene, or blends thereof;
the bio-based lignocellulosic particulate filler is almond shell powder having a particle size of less than 500 μm; and
the reactive coupling agent comprises a maleic-anhydride-grafted polyolefin selected from the group consisting of maleic-anhydride-grafted polypropylene, maleic-anhydride-grafted polyethylene, or combinations thereof.

19. The method of claim 18, further comprising:
forming the moldable extrudate into a final article using a melt-processing technique selected from compression molding, injection molding, or profile extrusion.

20. The method of claim 19, wherein the almond shell powder is present in an amount from about 10 wt % to about 60 wt % of the total composition.
